(19) United States
(12) Patent Application Publication
(10) Pub. No.: US 2025/0121456 A1
(43) Pub. Date: Apr. 17, 2025

(54) DEVICE FOR HEAT CONTROL OF LASER WELDING OF DISSIMILAR ADDITIVELY-MANUFACTURED PARTS

(71) Applicant: NANJING UNIVERSITY OF AERONAUTICS AND ASTRONAUTICS, Nanjing (CN)

(72) Inventors: Xiaohong ZHAN, Nanjing (CN); Yanqiu ZHAO, Nanjing (CN); Hengchang BU, Nanjing (CN); Leilei WANG, Nanjing (CN); Ruizu LIU, Nanjing (CN)

(21) Appl. No.: 19/002,014

(22) Filed: Dec. 26, 2024

(30) Foreign Application Priority Data
Jul. 3, 2024 (CN) 202410891720.5

(51) Int. Cl. B23K 26/21; B22F 7/06; B23K 26/14; B33Y 40/20

(52) U.S. Cl. CPC B23K 26/21; B22F 7/062; B23K 26/1462; B33Y 40/20

(57) ABSTRACT

A device for heat control in laser welding of dissimilar additively-manufactured parts includes a welding main body, a moving frame, a lifting frame, a laser welding head, a temperature control mechanism, a pressing mechanism, and a supporting and cleaning mechanism. The moving frame is mounted on the welding main body. The lifting frame is provided on the moving frame. The temperature control mechanism includes a welding platform designed to hold a laser metal deposition (LMD) printed part and a selective laser melting (SLM) printed part. The laser welding head is provided on the underside of the lifting frame for to weld the LMD part to the SLM part.

### CROSS-REFERENCE TO RELATED APPLICATIONS

This application claims the benefit of priority from Chinese Patent Application No. 202410891720.5, filed on Jul. 3, 2024. The content of the aforementioned application, including any intervening amendments made thereto, is incorporated herein by reference in its entirety.

### TECHNICAL FIELD

This application relates to laser welding, and more particularly to a device for heat control of laser welding of dissimilar additively-manufactured parts.

### BACKGROUND

The laser additive manufacturing-welding integrated process synergistically combines the strengths of selective laser melting (SLM), laser metal deposition (LMD), and laser welding. This innovative approach can significantly enhance the processing precision and design flexibility, reduced stress concentrations and reduce the fatigue-sensitive regions, making it a promising solution for the rapid fabrication of complex structures. However, this manufacturing process inevitably involves the welding between structures produced by SLM and LMD. Notably, LMD-printed parts typically exhibit coarser grains, while SLM-printed parts possess finer grain structures. The microstructure and properties of the weld joint are significantly influenced by the parent material's microstructure leading to significant non-uniformity in the grain structure and suboptimal service performance.

Additionally, in the prior art, the laser welding between additively-manufactured parts made of different materials is generally accompanied by ultra-high temperature, and in the case of dimensional errors, the laser beams may continue to emit even after the welding operation is completed, potentially ablating the welding platform or damaging the welding machine, leading to equipment damage and economic loss. Furthermore, some materials will experience obvious deformation when exposed to a sharp temperature rise during the printing process, ultimately reducing the welding accuracy. As a result, the printed material may fail to meet the dimensional requirement, or may be directly discarded, causing significant economic losses.

This application aims to propose a heat control device for the laser welding process of dissimilar additively-manufactured parts. The device can effectively regulate the heat generation during the welding process through the synergistic action of an external cooling medium and a thermal field, thereby achieving desired uniformity in the microstructure and mechanical properties of the laser weld joints between dissimilar additively-manufactured parts.

### SUMMARY

An object of the disclosure is to provide a device for heat control of laser welding of dissimilar additively-manufactured parts to overcome the defects in the prior art.

Technical solutions of the present disclosure are described as follows.

A device for heat control of laser welding of dissimilar additively-manufactured parts, comprising:
a welding main body;
a temperature control mechanism; and
a pressing mechanism;
wherein the welding main body is provided with a moving frame; the moving frame is provided with a lifting frame; and a bottom side of the lifting frame is provided with a laser welding head;
the temperature control mechanism is configured to perform heat control during a welding process, and comprises a welding platform; the welding platform is configured to hold a laser metal deposition (LMD) printed part and a selective laser melting (SLM) printed part; the laser welding head is configured to weld the LMD printed part to the SLM printed part; a moving table is provided above the welding platform, and is configured to follow a welding path; an underside of the moving table is provided with a protective gas nozzle and a first slide block; the first slide block is extendable; a side of the protective gas nozzle is connected to a liquid nitrogen cylinder and a protective gas cylinder; the protective gas nozzle is configured to spray cooled protective gas onto a surface of a welding pool for protection and cooling during the welding process; a bottom side of the first slide block is provided with a rotary rolling-heating head, and the rotary rolling-heating head is configured to perform rotary rolling and heating on a welded seam at a rear end of the welding pool;
the pressing mechanism is provided on the laser welding head; the pressing mechanism is configured to protect the laser welding head, and press the LMD printed part and the SLM printed part; the pressing mechanism comprises a sleeve base, and the sleeve base is sleeved on the laser welding head; a rotating baffle is rotatably provided on a bottom side of the sleeve base, and is configured to enclose the laser welding head; two sides of the sleeve base are each movably provided with a pressing gear rack; a side of the pressing gear rack is rotatably provided with a pressing wheel; and the pressing wheel is configured to apply pressure to the LMD printed part and the SLM printed part
the pressing mechanism is provided with a supporting and cleaning mechanism configured to support and clean a gap between the LMD printed part and the SLM printed part; the supporting and cleaning mechanism comprises two support frames; the two support frames are movably provided on a bottom of the rotating baffle; and a bottom side of each of the two support frames is movably provided with a telescopic rod.

In an embodiment, the temperature control mechanism further comprises a water-cooling copper block and a heating copper block; and the water-cooling copper block and the heating copper block are embedded within the welding platform; and the water-cooling copper block is provided on a bottom side of the LMD printed part, and is configured to cool the LMD printed part; and the heating copper block is provided on a bottom side of the SLM printed part, and is configured to heat the SLM printed part.

In an embodiment, the protective gas cylinder is connected to a first end of a protective gas pipe, and a second end of the protective gas pipe is connected to the protective gas nozzle; and a cavity is integrated within the moving table, and the protective gas pipe is provided within the cavity; and
the liquid nitrogen cylinder is connected to a first end of a liquid nitrogen delivery pipe, and a second end of the liquid nitrogen delivery pipe is configured to extend into the cavity to cool the protective gas pipe.

In an embodiment, the bottom side of the moving table is provided with two lifting cylinders configured to drive the moving table for vertical movement; and
two slideways are provided on a top side of the welding platform, and each of the two slideways is slidably provided with a second slide block; and two second slide blocks are provided on the two lifting cylinders, respectively.

In an embodiment, the pressing mechanism further comprises a closing plate; and the closing plate is movably provided on the rotating baffle, and is configured to cover the laser welding head; and
the closing plate is connected to a first end of a support spring, and a second end of the support spring is provided on the rotating baffle.

In an embodiment, two sides of the rotating baffle are each provided with a slewing frame; and the two sides of the sleeve base are each rotatably provided with the slewing frame; and
a side of the slewing frame away from the rotating baffle is provided with a reset gear, and the reset gear engages with the pressing gear rack; the two sides of the sleeve base are each provided with a limiting slot; and the pressing gear rack is slidably accommodated within the limiting slot.

In an embodiment, the two sides of the sleeve base are each provided with a rotating groove; a rotating shaft is rotatably provided within the rotating groove; and the slewing frame and the reset gear are sleeved on the rotating shaft;
an inner wall of the rotating groove is connected with a first end of a rebound torsion spring, and a second end of the rebound torsion spring is provided on the rotating shaft; and
an insert sleeve is fitted onto the sleeve base, and the laser welding head is insertedly provided on the moving table through the insert sleeve.

In an embodiment, the supporting and cleaning mechanism further comprises two linkage frames, and the two linkage frames are provided on top sides of the two support frames, respectively; and
a side of the rotating baffle is rotatably provided with two adjusting rotating rods; each of the two adjusting rotating rods is rotatably provided with a coupling shaft; and the coupling shaft is movably provided within each of the two linkage frames.

In an embodiment, a top end of each of the two adjusting rotating rods is provided with a synchronous gear, and two synchronous gears are configured to be engaged with each other; and
the side of the rotating baffle is provided with two gear shafts; the two synchronous gears are rotatably provided on the two gear shafts, respectively; and one of the two gear shafts is threadedly provided with a locking nut.

In an embodiment, a top side of the telescopic rod is provided with a return spring, and a top end of the return spring is provided on an inner wall of a top side of each of the two support frames; and
an adjusting slot is provided on the bottom of the rotating baffle, and the two support frames are slidably provided within the adjusting slot.

Compared to the prior art, the present disclosure has the following beneficial effects.

In the present disclosure, the temperature control mechanism is mounted, such that the water-cooling copper block is provided beneath the LMD printed part to provide rapid cooling of the LMD printed part during the welding process. The heating copper block is positioned beneath the SLM printed part to provide preheating, concurrent heating, and post-heating during the welding process. The protective gas within the protective gas cylinder is input into the protective gas nozzle through the protective gas pipe, while nitrogen from the liquid nitrogen cylinder is supplied to the cavity of the moving table to cool the protective gas, achieving continuous cooling. The cooled protective gas reaches a surface of the welding pool through the protective gas nozzle, providing protection and cooling during the welding process, to refine the weld seam grains. In addition, during the movement of the moving table, a side of the SLM printed part is heated through the rotation of the rotary rolling-heating head, thus achieving rotary rolling and heating of the weld seam at the rear end of the welding pool, so as to achieve the purpose of coarsening the grains of the weld seam, facilitating the homogenization regulation of the microstructure of the weld joint, addressing issues such as the disordered distribution of the microstructure and the decline of mechanical properties in the welding joints of dissimilar additively-manufactured parts.

Furthermore, in the present disclosure, the pressing mechanism ensures that when the laser welding head descends for welding, the two pressing wheels can press against the LMD printed part and the SLM printed part respectively, preventing the LMD printed part and the SLM printed part from being deformed due to temperature changes during the printing process. Meanwhile, as the laser welding head continuously moves and disengages from the printed parts, the rotating baffle can promptly return to its original position to enclose the laser welding head completely, preventing damage to the welding platform caused by prolonged laser exposure. Moreover, enclosing the laser head can also prevent the laser welding head from being damaged by collision when loading or unloading printed parts or in other unexpected situations, thereby ensuring the safety of components such as the welding platform and the laser welding head.

Furthermore, in the present disclosure, by means of the supporting and cleaning mechanism, during welding, a distance between the two support frames is adjusted according to a position of the weld seam. Moreover, when the rotating baffle unfolds, the two support frames are configured to respectively drive the two telescopic rods to come into contact with side edges of the two printed parts, supporting the weld seam and preventing deformation that could otherwise alter the weld seam dimensions. Meanwhile, when the rotating baffle moves, it drives the support frames and the telescopic rods to move to clean the side edges of the two printed parts, thus ensuring the quality of welding process.

### BRIEF DESCRIPTION OF THE DRAWINGS

FIG. 1 is a perspective view of a device for heat control of laser welding of dissimilar additively-manufactured parts in accordance with an embodiment of the present disclosure;

FIG. 2 is a structural diagram of a connection among a laser welding head, a pressing mechanism and other structures in accordance with an embodiment of the present disclosure;

FIG. 3 is a structural diagram of a connection among a welding platform, a laser metal deposition (LMD) printed part and other structures in accordance with an embodiment of the present disclosure;

FIG. 4 is a structural diagram of a connection among a lifting cylinder, a second slide block and other structures in accordance with an embodiment of the present disclosure;

FIG. 5 is a structural diagram of portion “A” shown in FIG. 4;

FIG. 6 is a sectional view of a connection among a moving table, a liquid nitrogen cylinder and other structures in accordance with an embodiment of the present disclosure;

FIG. 7 is a partial sectional view of a connection among a sleeve base, a rotating shaft and other structures in accordance with an embodiment of the present disclosure;

FIG. 8 is a structural diagram of a connection among a rotating baffle, a support frame and other structures in accordance with an embodiment of the present disclosure;

FIG. 9 is a structural diagram of a connection among the rotating baffle, a closing plate and other structures in accordance with an embodiment of the present disclosure; and

FIG. 10 is a structural diagram of a connection among the support frame, a telescopic rod and other structures in accordance with an embodiment of the present disclosure.

In the figures: 1—welding main body; 2—moving frame; 3—lifting frame; 4—laser welding head; 5—temperature control mechanism; 501—welding platform; 502—laser metal deposition (LMD) printed part; 503—selective laser melting (SLM) printed part; 504—water-cooling copper block; 505—heating copper block; 506—moving table; 507—protective gas nozzle; 508—first slide block; 509—rotary rolling-heating head; 510—liquid nitrogen cylinder; 511—protective gas cylinder; 512—liquid nitrogen delivery pipe; 513—protective gas pipe; 514—lifting cylinder; 515—second slide block; 516—slideway; 6—pressing mechanism; 601—sleeve base; 602—rotating baffle; 603—slewing frame; 604—rotating shaft; 605—rotating groove; 606—rebound torsion spring; 607—reset gear; 608—pressing gear rack; 609—pressing wheel; 610—limiting slot; 611—closing plate; 612—support spring; 613—insert sleeve; 7—supporting and cleaning mechanism; 701—support frame; 702—telescopic rod; 703—return spring; 704—adjusting slot; 705—adjusting rotating rod; 706—coupling shaft; 707—synchronous gear; 708—gear shaft; 709—locking nut; and 710—linkage frame.

### DETAILED DESCRIPTION OF EMBODIMENTS

In order to make the objects, technical solutions and advantages of the present disclosure clearer, the present disclosure will be described clearly and completely below in conjunction with the accompanying drawings and embodiments. Obviously, described herein are merely some embodiments of the present disclosure, rather than all embodiments. The components of embodiments of the present disclosure described and shown in the accompanying drawings may be arranged and designed in various ways.

Thus, the following detailed description of embodiments of the present disclosure provided in the accompanying drawings is not intended to limit the scope of the present disclosure, but rather represents only selected embodiments of the present disclosure. Based on the embodiments in the present disclosure, all other embodiments obtained by those of ordinary skill in the art without making creative effort shall fall within the scope of the present disclosure defined by the appended claims.

It should be noted that similar reference numerals and letters in the following accompanying drawings indicate similar items. Therefore, once an item is defined in one accompanying drawing, it does not require further definition or explanation in the subsequent accompanying drawings.

Additionally, in the description of the present disclosure, it should be noted that, as used herein, terms “center”, “up”, “down”, “vertical”, “horizontal”, “inner” and “outer” are based on the those shown in the accompanying drawings. These terms are used solely for convenience in describing the present disclosure, and are not intended to imply that the devices or components must have specific orientations or be constructed or operated in any particular way. Therefore, these terms should not be understood as limitations of the present disclosure. Furthermore, as used herein, terms “first”, “second” and “third” are merely used to distinguish technical features, rather than indicating or implying their relative importance.

Additionally, as used herein, terms “horizontal”, “vertical” and “perpendicular” do not require the components to be absolutely vertical; but allow for slight inclinations. For example, “vertical” merely refers to a direction that is more upright relative to “horizontal”, and does not imply that the structure must be perfectly vertical, but rather that it may be slightly inclined.

In the description of the present disclosure, it should also be noted that, unless otherwise specifically defined, as used herein, terms “arranged”, “mounted”, “connected” and “coupled” should be broadly understood. For example, these terms may refer to fixed connections, detachable connections, or integral connections; mechanical connections, electrical connections, direct connections or indirect connections through intermediate media; or communication between two components internally. For those of ordinary skill in the art, the specific meaning of these terms in the present disclosure can be understood based on the context.

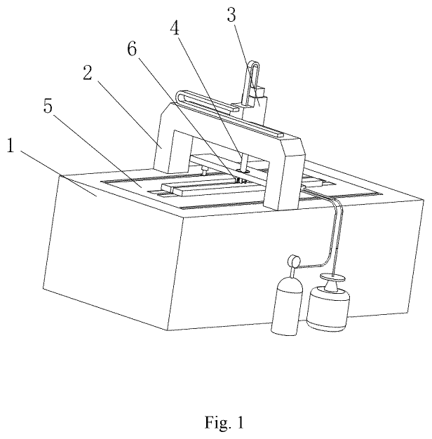

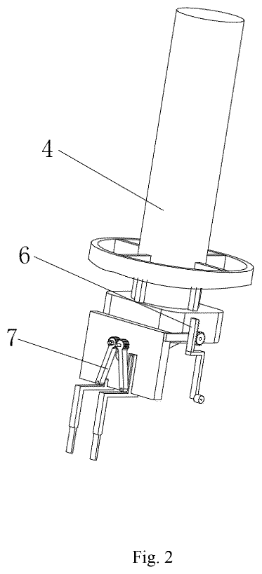

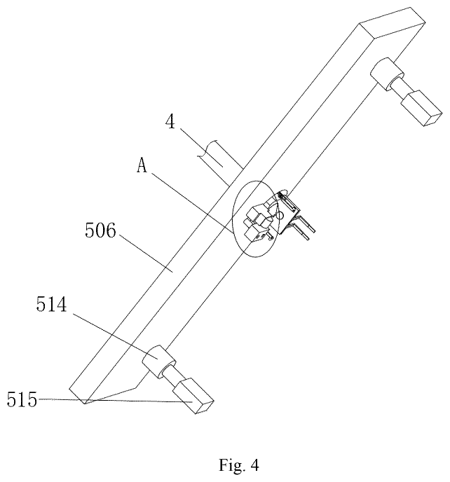

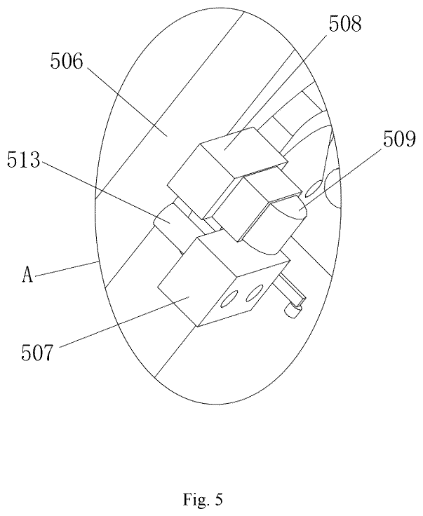

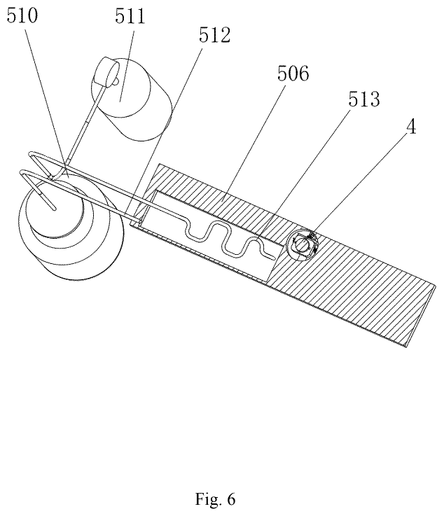

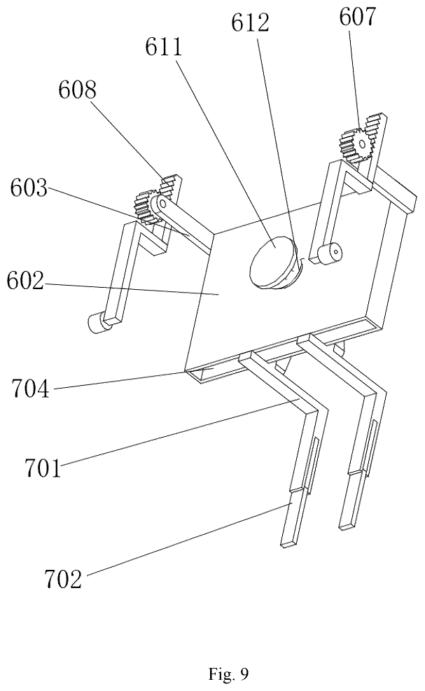

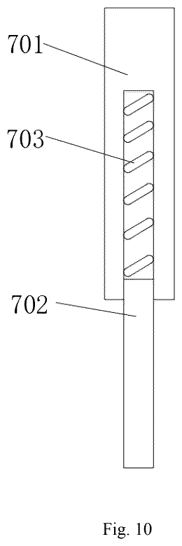

As shown in FIGS. 1-10, an embodiment of the present application provides a device for heat control of laser welding of dissimilar additively-manufactured parts, including a welding main body 1. The welding main body 1 is provided with a moving frame 2. The moving frame 2 is provided a lifting frame 3. A bottom side of the lifting frame 3 is provided with a laser welding head 4 configured for welding.

More specifically, the device further includes a temperature control mechanism 5, which is configured to precisely regulate the heat during the welding process. The temperature control mechanism 5 includes a welding platform 501, on which a laser metal deposition (LMD) printed part 502 and a selective laser melting (SLM) printed part 503 are placed. The laser welding head 4 is configured to perform welding between the LMD printed part 502 and the SLM printed part 503. A moving table 506 is provided above the welding platform 501, and is configured to follow a welding path. An underside of the moving table 506 is provided with a protective gas nozzle 507 and a first slide block 508. The first slide block 508 is extendable. A side of the protective gas nozzle 507 is connected to a liquid nitrogen cylinder 510 and a protective gas cylinder 511. The protective gas nozzle 507 is configured to spray cooled protective gas onto a surface of a welding pool for protection and cooling during the welding process. A bottom side of the first slide block 508 is provided with a rotary rolling-heating head 509. The rotary rolling-heating head 509 is configured to perform rotary rolling and heating on a welded seam at a rear end of the welding pool. It should be noted that, in an embodiment of the present disclosure, protective gas from the protective gas cylinder 511 is introduced into the protective gas nozzle 507 through the protective gas pipe 513. Meanwhile, nitrogen from the liquid nitrogen cylinder 510 is supplied to a cavity of the moving table 506 to cool the protective gas, thereby achieving continuous cooling of the protective gas. The cooled protective gas reaches a surface of the welding pool through the protective gas nozzle 507, providing protection and cooling during the welding process, thereby refining the grains of the weld seam. Furthermore, when the moving table 506 moves, the rotation of the rotary rolling-heating head 509 heats a side of the SLM printed part 503, performing rotary rolling and heating of the weld seam at the rear end of the welding pool, further achieving the coarsening of the weld seam grains.

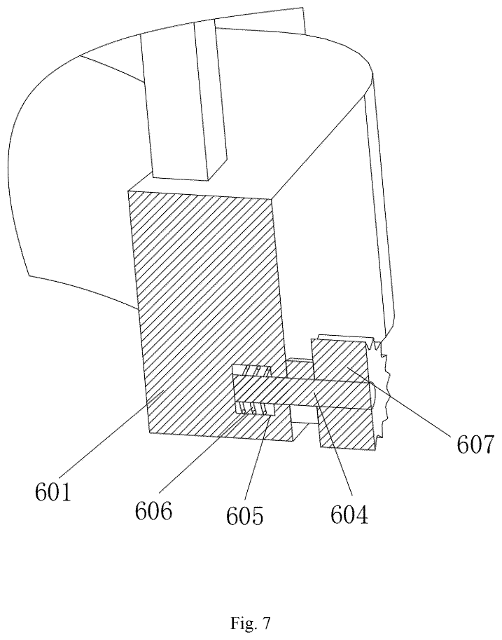

Furthermore, as shown in FIGS. 7-9, the device further includes a pressing mechanism 6 provided on the laser welding head 4. The pressing mechanism 6 is configured to protect the laser welding head 4, and apply pressure to the LMD printed part 502 and the SLM printed part 503. Specifically, the pressing mechanism 6 includes a sleeve base 601, and the sleeve base 601 is sleeved on the laser welding head 4. A rotating baffle 602 is rotatably provided on a bottom side of the sleeve base 601, and is configured to enclose the laser welding head 4. Two sides of the sleeve base 601 are each movably provided with a pressing gear rack 608. A side of the pressing gear rack 608 is rotatably provided with a pressing wheel 609. The pressing wheel 609 is configured to press against the LMD printed part 502 and the SLM printed part 503. It should be noted that, in this embodiment, when the laser welding head 4 descends for welding, the rotating baffle 602 opens, the two pressing gear racks 608 can drive the two pressing wheels 609 to press the LMD printed part 502 and the SLM printed part 503, respectively, preventing the LMD printed part 502 and the SLM printed part 503 from being deformed due to temperature changes during the printing process. Meanwhile, when the rotating baffle 602 closes, it prevents damage to the welding platform 501 caused by prolonged laser exposure. Additionally, it helps to avoid damage to the laser welding head 4 caused by collisions during the loading or unloading of the printed parts or other unexpected situations, thereby fully ensuring the safety of both the welding platform 501 and the laser welding head 4.

More specifically, the pressing mechanism 6 is provided with a supporting and cleaning mechanism 7. The supporting and cleaning mechanism 7 is configured to support and clean a gap between the LMD printed part 502 and the SLM printed part 503. The supporting and cleaning mechanism 7 includes two support frames 701, the two support frames 701 are movably provided on a bottom of the rotating baffle 602. A bottom side of each of the two support frames 701 is movably attached to a telescopic rod 702. It should be noted that, in an embodiment, a distance between the two support frames 701 can be adjusted according to a position of the weld seam during the welding process. The two support frames 701 are configured to respectively drive the two telescopic rods 702 to come into contact with side edges of the two printed parts, so as to support the weld seam and avoid the problem that the deformation of the two printed parts could cause the changes in the weld seam dimensions. Meanwhile, when the rotating baffle 602 moves, it drives the support frames 701 and the telescopic rods 702 to move to clean the side edges of the two printed parts, thereby ensuring the welding quality.

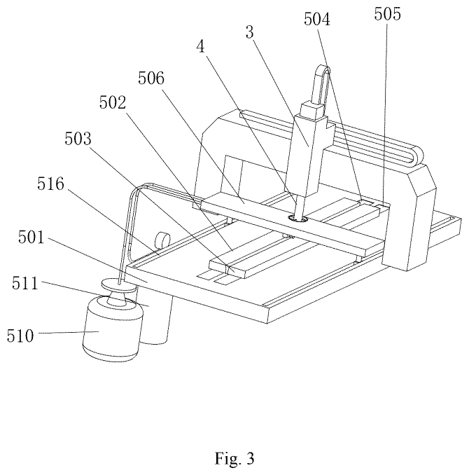

Referring to an embodiment shown in FIGS. 3-6, the temperature control mechanism 5 further includes a water-cooling copper block 504 and a heating copper block 505. The water-cooling copper block and the heating copper block are embedded within the welding platform 501. The water-cooling copper block 504 is provided on a bottom side of the LMD printed part 502, and is configured to cool the LMD printed part 502. The heating copper block 505 is provided on a bottom side of the SLM printed part 503, and is configured to heat the SLM printed part 503. It should be noted that, in this embodiment, the water-cooling copper block 504 is provided beneath the LMD printed part 502 to provide rapid cooling of the LMD printed part 502 during the welding process. The heating copper block 505 is provided beneath the SLM printed part 503 to heat the SLM printed part 503 before, during, and after the welding process.

More specifically, the protective gas cylinder 511 is connected to a first end of a protective gas pipe 513, and a second end of the protective gas pipe 513 is connected to the protective gas nozzle 507. A cavity is provided within the moving table 506, and the protective gas pipe 513 is provided within the cavity of the moving table 506.

In addition, the liquid nitrogen cylinder 510 is connected to a first end of a liquid nitrogen delivery pipe 512, and a second end of the liquid nitrogen delivery pipe is configured to extend into the cavity of the moving table 506 to cool the protective gas pipe 513. It should be noted that, in an embodiment, the protective gas from the protective gas cylinder 511 is introduced into the protective gas nozzle 507 through the protective gas pipe 513. Meanwhile, nitrogen from the liquid nitrogen cylinder 510 is supplied to the cavity of the moving table 506 to cool the protective gas, thereby achieving continuous cooling of the protective gas. The cooled protective gas reaches the surface of the welding pool through the protective gas nozzle 507, providing protection and cooling during the welding process, and thereby refining the grains of the weld seam. Furthermore, as the moving table 506 moves, the rotation of the rotary rolling-heating head 509 heats the side of the SLM printed part 503, performing rotary rolling and heating of the weld seam at the rear end of the welding pool, thereby promoting the grain coarsening in the weld seam.

As shown in FIGS. 3-6, in an embodiment of the present disclosure, the bottom side of the moving table 506 is provided with two lifting cylinders 514 configured to drive the moving table 506 for vertical movement. Additionally, two slideways 516 are provided on a top side of the welding platform 501. Each of the two slideways 516 is slidably provided with a second slide block 515. Two second slide blocks 515 are provided on the two lifting cylinders 514, respectively. It should be noted that, in an embodiment of the present disclosure, during the movement of the laser welding head 4, the moving table 506 moves, which in turn drives the two lifting cylinders 514 to move, such that the two lifting cylinders 514 can slide along the two slideways 516 through the two second slide blocks 515. And the lifting cylinders 514 are configured to drive the moving table 506 to move vertically, such that the protective gas nozzle 507 and the first slide block 508 are closed to the printed parts.

Further, as shown in FIGS. 7-9, in an embodiment, the pressing mechanism 6 further includes a closing plate 611. The closing plate 611 is movably provided on the rotating baffle 602, and is configured to cover the laser welding head 4. Specifically, the closing plate 611 is connected to a first end of a support spring 612, and a second end of the support spring 612 is provided on the rotating baffle 602. It should be noted that, in this embodiment, when the rotating baffle 602 returns to its original position, it encloses the laser welding head 4 through the closing plate 611. Additionally, as the closing plate 611 returns, it is pressed by the laser welding head 4, causing the support spring 612 to be under force. This ensures that the closing plate 611 to move along the rotating baffle 602, allowing it to securely cover the laser welding head 4 securely.

More specifically, in an embodiment of the present disclosure, two side of the rotating baffle 602 are each provided with a slewing frame 603. The two sides of of the sleeve base 601 are each rotatably provided with the slewing frame 603. Additionally, a side of the slewing frames 603 away from the rotating baffle 602 is provided with a reset gear 607. The reset gear 607 is engaged with the pressing gear rack 608. The two sides of the sleeve base 601 are each provided with a limiting slot 610. The pressing gear rack 608 is slidably provided in the limiting slots 610. It should be noted that, in this embodiment, when the laser welding head 4 descends, the two pressing wheels 609 can press against the LMD printed part 502 and the SLM printed part 503, respectively, preventing the LMD printed part 502 and the SLM printed part 503 from being deformed due to temperature changes during printing. Meanwhile, when the pressing wheel 609 is forced to move, it drives the pressing gear rack 608 to slide vertically within the limiting slot 610, causing the pressing gear rack 608 to rotate the rotating baffle 602 to open. At this point, the laser welding head 4 is exposed, allowing the welding process to begin. As the laser welding head 4 continues to move during welding, once it disengages from the printed parts, the rotating baffle 602 can return to its original position to enclose the laser welding head 4, thus avoiding the damage to the welding platform 501 caused by prolonged laser exposure.

It should be emphasized that the closing plate 611 is made of a stone or other materials that are not easily cut by lasers, such that it can block the laser in the event that the laser is not fully covered, thereby ensuring the safety of the welding platform 501.

With reference to an embodiment shown in FIGS. 7-9, the two sides of the sleeve base 601 are each provided with a rotating groove 605. A rotating shaft 604 is rotatably positioned within the rotating groove 605. The slewing frame 603 and the reset gear 607 are mounted on the rotating shaft 604. An inner wall of the rotating groove 605 is connected with a first end of a rebound torsion spring 606, and a second end of the rebound torsion spring 606 is provided on the rotating shaft 604.

Additionally, an insert sleeve 613 is fitted onto the sleeve base 601, and the laser welding head 4 is insertedly provided on the moving table 506 through the insert sleeve 613. It should be noted that, in this embodiment, when the reset gear 607 rotates, it drives the slewing frame 603 to rotate through the rotating shaft 604, thereby synchronously driving the opening of the rotating baffle 602. Meanwhile, the rotating shaft 604 rotates within the rotating groove 605 and causes the rebound torsion spring 606 to be under force. As a result, when the laser welding head 4 returns to its original position, the rotating shaft 604 can be reset under the action of rebound force of the rebound torsion spring 606, making it easier for the rotating baffle 602 to return to its original position. Furthermore, when the laser welding head 4 descends for welding, the insert sleeve 613 inserts into the moving table 506, so as to make the moving table 506 move in step with the movement of the laser welding head 4.

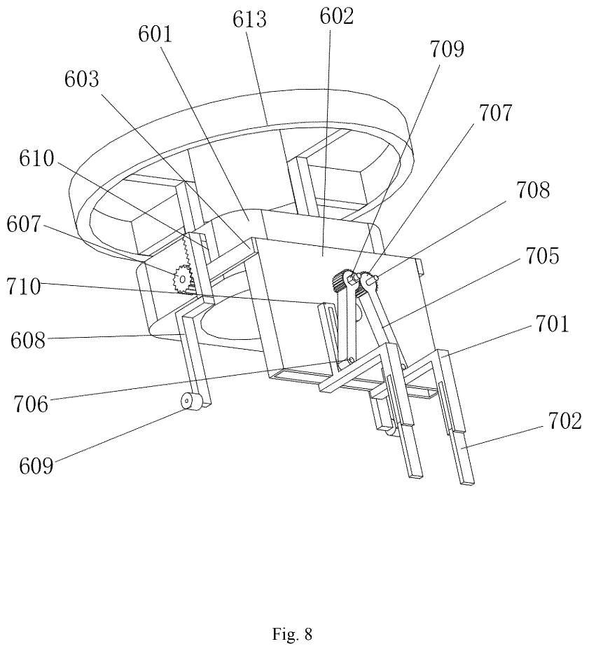

Furthermore, as shown in FIGS. 8-10, in an embodiment of the present disclosure, the supporting and cleaning mechanism 7 further includes two linkage frames 710, and the two linkage frames 710 are provided on top sides of the two support frames 701, respectively. Additionally, one of the two sides of the rotating baffle 602 is rotatably provided with two adjusting rotating rods 705. Each of the two adjusting rotating rods 705 is rotatably provided with a coupling shaft 706. The coupling shaft 706 is movably provided within each of the two linkage frames 710. It should be noted that, in an embodiment of the present disclosure, when adjusting the distance between the two support frames 701, one synchronous gear 707 rotates, which in turn drives the other synchronous gear 707 to rotate as well. This action drives the two adjusting rotating rods 705 to rotate, allowing them to drive the two linkage frames 710 to move through the two coupling shafts 706. As a result, the linkage frames 710 drive the support frames 701 to move, completing the adjustment of the position of the support frames 701.

More specifically, in an embodiment of the present disclosure, a top end of each of the two adjusting rotating rods 705 is provided with the synchronous gear 707, and two synchronous gears 707 are configured to be engaged with each other. The side of the rotating baffle 602 where the two adjusting rotating rods 705 are provided is provided with two gear shafts 708. The two synchronous gears 707 are rotatably provided on the two gear shafts 708, respectively. One of the two gear shafts 708 is threadedly provided with a locking nut 709. It should be noted that, in an embodiment of the present disclosure, during welding, the distance between the two support frames 701 can be adjusted according to the position of the weld seam. At this point, one synchronous gear 707 is rotated, which in turn drives the other synchronous gear 707 to rotate in an opposite direction. The two synchronous gears 707 rotate on the two gear shafts 708, thereby driving the two adjusting rotating rods 705 to rotate. This, in turn, enables the adjustment of the position of the support frame 701. Once the adjustment is complete, the locking nut 709 is tightened to secure the synchronous gears 707, thus locking the position of the support frame 701.

With continued reference to FIGS. 8-10, more specifically, in an embodiment of the present disclosure, a top side of the telescopic rod 702 is provided with a return spring 703. And a top end of the return spring 703 is provided on an inner wall of a top side of each of the two support frames 701. An adjusting slot 704 is provided on the bottom of the rotating baffle 602. The two support frames 701 are slidably provided within the adjusting slot 704. It should be noted that, in an embodiment of the present disclosure, when the support frame 701 moves, it slides horizontally within the adjusting slot 704. As the support frame 701 extends, the telescopic rod 702 comes into contact with the welding platform 501 and is compressed, causing the telescopic rod 702 to retract within the support frame 701, thus putting the return spring 703 under force.

In summary, the working principle of the device provided herein is as follows.

The water-cooling copper block 504 is positioned beneath the LMD printed part 502 to provide rapid cooling of the LMD printed part 502 during the welding process. The heating copper block 505 is provided beneath the SLM printed part 503 to heat the SLM printed part 503 before, during, and after the welding process. The protective gas within the protective gas cylinder 511 is input into the protective gas nozzle 507 through the protective gas pipe 513, while nitrogen from the liquid nitrogen cylinder 510 is supplied to the cavity of the moving table 506 to cool the protective gas, achieving continuous cooling. The cooled protective gas reaches a surface of the welding pool through the protective gas nozzle 507, providing protection and cooling during the welding process, to refine the grains of the weld seam. In addition, as the moving table 506 advances, the rotation of the rotary rolling-heating head 509 achieves rotary rolling and heating of the weld seam at the rear end of the welding pool, so as to achieve the grain coarsening of the weld seam.

Furthermore, when the laser welding head 4 descends for welding, it drives the sleeve base 601 to move, allowing the insert sleeve 613 to be inserted into the moving table 506. Then, the laser welding head 4 can drive the moving table 506 through the insert sleeve 613, ensuring continuous temperature control of the weld seam. At the same time, as the laser welding head 4 descends, the two pressing wheels 609 can press against the LMD printed part 502 and the SLM printed part 503 respectively, preventing the LMD printed part 502 and the SLM printed part 503 from being deformed due to temperature changes during printing. Meanwhile, when the pressing wheel 609 is forced to move, it drives the pressing gear rack 608 to slide vertically within the limiting slot 610. This, in turn, causes the pressing gear rack 608 to rotate the reset gear 607, which then drives the rotating shaft 604 to rotate within the rotating groove 605, putting the rebound torsion spring 606 under force. Meanwhile, the rotating shaft 604 drives the slewing frame 603 to rotate, causing the slewing frame 603 to rotate the rotating baffle 602 to open. At this point, the laser welding head 4 is exposed and welding can begin.

Furthermore, as the laser welding head 4 continues to move and disengages from the printed parts, the pressing wheel 609 loses pressure. At this point, under the rebound force of the rebound torsion spring 606, the rotating shaft 604 can drive the rotating baffle 602 to return to its original position through the slewing frame 603. This, in turn, drives the closing plate 611 to cover the laser welding head 4, thus avoiding damage to the welding platform 501 caused by prolonged laser exposure. Meanwhile, as the closing plate 611 returns, it is pressed by the laser welding head 4, causing the closing plate 611 to move along the rotating baffle 602, ensuring that the closing plate 611 can securely cover the laser welding head 4. This also prevent the laser welding head from being damaged by collision when loading or unloading printed parts or in other unexpected situations. And the closing plate 611 is made of the stone or other materials that are not easily cut by lasers, protecting the welding platform 501 when the laser is not fully covered.

Furthermore, during welding, the distance between the two support frames 701 can be adjusted according to the position of the weld seam. At this point, one synchronous gear 707 rotates, which in turn drives the other synchronous gear 707 to rotate in the opposite direction. And the two synchronous gears 707 rotate on the two gear shafts 708. This action drives the two adjusting rotating rods 705 to rotate, allowing them to drive the two linkage frames 710 to move via the two coupling shafts 706. Consequently, the linkage frames 710 move the support frames 701, completing the adjustment of the position of the support frames 701. Once the adjustment is complete, the locking nuts 709 are tightened to secure the position of the support frames 701. Additionally, when the rotating baffle 602 unfolds, the two support frames 701 can respectively drive the two telescopic rods 702 to come into contact with the sides edges of the two printed parts, so as to support the weld seam and avoid the problem that the deformation of the two printed parts that could otherwise cause the changes in the weld seam dimensions. Meanwhile, as the rotating baffle 602 moves, it drives the support frames 701 and the telescopic rods 702 to move, allowing for cleaning of the side edges of the two printed parts, thereby ensuring the quality of the welding process.

The embodiments described above are merely illustrative of the present disclosure, and are not intended to limit the scope of the present disclosure. It should be understood that various changes or substitutions made by those of ordinary skill in the art without departing from the spirit of the present disclosure shall fall within the scope of the present disclosure defined by the appended claims.

What is claimed is:

1. A device for heat control of laser welding of dissimilar additively-manufactured parts, comprising:
a welding main body;
a temperature control mechanism; and
a pressing mechanism;
wherein the welding main body is provided with a moving frame; the moving frame is provided with a lifting frame; and a bottom side of the lifting frame is provided with a laser welding head;
the temperature control mechanism is configured to perform heat control during a welding process, and comprises a welding platform; the welding platform is configured to hold a laser metal deposition (LMD) printed part and a selective laser melting (SLM) printed part; the laser welding head is configured to weld the LMD printed part to the SLM printed part; a moving table is provided above the welding platform, and is configured to follow a welding path; an underside of the moving table is provided with a protective gas nozzle and a first slide block; the first slide block is extendable; a side of the protective gas nozzle is connected to a liquid nitrogen cylinder and a protective gas cylinder; the protective gas nozzle is configured to spray cooled protective gas onto a surface of a welding pool for protection and cooling during the welding process; a bottom side of the first slide block is provided with a rotary rolling-heating head, and the rotary rolling-heating head is configured to perform rotary rolling and heating on a welded seam at a rear end of the welding pool;
the pressing mechanism is mounted on the laser welding head; the pressing mechanism is configured to protect the laser welding head, and press the LMD printed part and the SLM printed part; the pressing mechanism comprises a sleeve base, and the sleeve base is fitted onto the laser welding head; a rotating baffle is rotatably provided on a bottom side of the sleeve base, and is configured to enclose the laser welding head; two sides of the sleeve base are each movably provided with a pressing gear rack; a side of the pressing gear rack is rotatably provided with a pressing wheel; and the pressing wheel is configured to apply pressure to the LMD printed part and the SLM printed part; and
the pressing mechanism is provided with a supporting and cleaning mechanism configured to support and clean a gap between the LMD printed part and the SLM printed part; the supporting and cleaning mechanism comprises two support frames; the two support frames are movably provided on a bottom of the rotating baffle; and a bottom side of each of the two support frames is movably provided with a telescopic rod.

2. The device of claim 1, wherein the temperature control mechanism further comprises a water-cooling copper block and a heating copper block; and the water-cooling copper block and the heating copper block are embedded within the welding platform; and
the water-cooling copper block is provided on a bottom side of the LMD printed part, and is configured to cool the LMD printed part; and the heating copper block is provided on a bottom side of the SLM printed part, and is configured to heat the SLM printed part.

3. The device of claim 2, wherein the protective gas cylinder is connected to a first end of a protective gas pipe, and a second end of the protective gas pipe is connected to the protective gas nozzle; and a cavity is provided within the moving table, and the protective gas pipe is provided within the cavity; and
the liquid nitrogen cylinder is connected to a first end of a liquid nitrogen delivery pipe, and a second end of the liquid nitrogen delivery pipe is configured to extend into the cavity to cool the protective gas pipe.

4. The device of claim 3, wherein the bottom side of the moving table is provided with two lifting cylinders configured to drive the moving table for vertical movement; and
two slideways are provided on a top side of the welding platform, and each of the two slideways is slidably provided with a second slide block; and two second slide blocks are provided on the two lifting cylinders, respectively.

5. The device of claim 1, wherein the pressing mechanism further comprises a closing plate; and the closing plate is movably provided on the rotating baffle, and is configured to cover the laser welding head; and
the closing plate is connected to a first end of a support spring, and a second end of the support spring is provided on the rotating baffle.

6. The device of claim 5, wherein two sides of the rotating baffle are each provided with a slewing frame; and the two sides of the sleeve base are each rotatably provided with the slewing frame; and
a side of the slewing frame away from the rotating baffle is provided with a reset gear; the reset gear is engaged with the pressing gear rack; the two sides of the sleeve base are each provided with a limiting slot; and the pressing gear rack is slidably provided within the limiting slot.

7. The device of claim 6, wherein the two sides of the sleeve base are each provided with a rotating groove; a rotating shaft is rotatably provided within the rotating groove; and the slewing frame and the reset gear are sleeved on the rotating shaft;
an inner wall of the rotating groove is connected with a first end of a rebound torsion spring, and a second end of the rebound torsion spring is provided on the rotating shaft; and
an insert sleeve is fitted onto the sleeve base, and the laser welding head is insertedly provided on the moving table through the insert sleeve.

8. The device of claim 1, wherein the supporting and cleaning mechanism further comprises two linkage frames, and the two linkage frames are provided on top sides of the two support frames, respectively; and
a side of the rotating baffle is rotatably provided with two adjusting rotating rods; each of the two adjusting rotating rods is rotatably provided with a coupling shaft; and the coupling shaft is movably provided within each of the two linkage frames.

9. The device of claim 8, wherein a top end of each of the two adjusting rotating rods is provided with a synchronous gear, and two synchronous gears are configured to be engaged with each other; and
the side of the rotating baffle is provided with two gear shafts; the two synchronous gears are rotatably provided on the two gear shafts, respectively; and one of the two gear shafts is threadedly provided with a locking nut.

10. The device of claim 9, wherein a top side of the telescopic rod is provided with a return spring, and a top end of the return spring is provided on an inner wall of a top side of each of the two support frames; and
an adjusting slot is provided on the bottom of the rotating baffle, and the two support frames are slidably provided within the adjusting slot.
